(19) United States
(12) Patent Application Publication
(10) Pub. No.: US 2023/0047331 A1
(43) Pub. Date: Feb. 16, 2023

(54) TIMEPIECE MECHANISM INDICATING INFORMATION RELATING TO AN AMBIENT PRESSURE COMPRISING A ZERO-RESET MECHANISM AND TIMEPIECE, SUCH AS A DIVING WATCH, COMPRISING SUCH A MECHANISM

(71) Applicant: BLANCPAIN SA, Le Brassus (CH)

(72) Inventors: Guillaume BOSCAROLI, Le Solliat (CH); Bernat MONFERRER, St-Prex (CH)

(73) Assignee: BLANCPAIN SA, Le Brassus (CH)

(21) Appl. No.: 17/749,600

(22) Filed: May 20, 2022

(30) Foreign Application Priority Data
Aug. 10, 2021 (EP) 21190618.5

(51) Int. Cl. G04B 47/06; G01C 5/06; G01L 19/10

(52) U.S. Cl. CPC G04B 47/066; G01C 5/06; G01L 19/10; B63C 11/02

(57) ABSTRACT

Provided is a timepiece mechanism (1, 1′) indicating information relating to the ambient pressure. The timepiece includes an ambient pressure measuring device that deforms mechanically due to ambient pressure variation. The device includes a first wheel assembly (31) kinematically linked to the ambient pressure measuring device that rotates under the effect of an ambient pressure variation and a measured pressure indicator mechanism (40) including a measured pressure indicator organ. The device also includes a second wheel assembly (33) configured to be in uncouplable connection with the first wheel assembly (31) so thesecond wheel assembly (33) is rotated by the first wheel assembly (31) under the effect of the pressure variation. Also included is a zero-reset mechanism (100) to position the measured pressure indicator organ (44) in a reference position by uncoupling the second wheel assembly (33) from the first wheel assembly (31).

### CROSS-REFERENCE TO RELATED APPLICATIONS

This application claims priority to European Patent Application No. 21190618.5 filed Aug. 10, 2021, the entire contents of which are incorporated herein by reference.

### TECHNICAL FIELD OF THE INVENTION

The field of the invention relates to timepiece mechanisms for measuring and indicating information relating to a physical variable, for example the ambient pressure, by means of an indicator organ and comprising a zero-reset mechanism.

The invention more particularly relates to a timepiece mechanism, indicating information relating to the ambient pressure, equipped with an ambient pressure measuring device associated with an indicator organ intended to display this pressure, or a variable (information) equivalent to this pressure, and comprising a zero-reset mechanism of the indicator organ.

The invention also relates to a horological movement comprising such a timepiece mechanism indicating information relating to the ambient pressure.

The invention also relates to a depth gauge integrating such a timepiece mechanism.

The invention also relates to an altimeter or a barometer integrating such a timepiece mechanism.

The invention also relates to a timepiece, such as a diving watch or an altimeter watch, comprising a horological movement comprising such a timepiece mechanism.

### TECHNOLOGICAL BACKGROUND

In the field of depth gauges, or timepieces, for measuring the ambient pressure, mechanisms are known comprising an ambient pressure measuring device associated with an indicator organ intended to display the ambient pressure, or information equivalent to this ambient pressure. These timepieces are most frequently used as diving watches.

Such depth gauges, or diving watches, make it possible to indicate the instantaneous depth of the diver and sometimes the maximum depth reached by the diver by means of a second indicator organ. These data are particularly important for the diver because they determine the duration and the depth of the stops during the ascent. Consequently, it is important for the user that these data are accurate.

However, current diving watches are not exclusively intended to be worn during dives but may be worn outside of water and particularly during various trips and at different altitudes from sea level.

Yet, the devices for measuring the ambient pressure equipping such diving watches are also sensitive to variations of the atmospheric pressure, due to altitude variations or to changes of meteorological conditions. These modifications of the ambient atmospheric pressure also result in a displacement of the measured pressure indicator organ around the theoretical zero value.

Diving watches, and depth gauges, are conventionally sealed by means of elastomer seals dimensioned to withstand liquids, and particularly various use pressures of the ambient pressure measuring device equipping the diving watches and the depth gauges. Although the seals have been the subject of developments to improve the permeability to gases, such as helium or hydrogen, they remain permeable to gas over time, even in a very limited way.

Thus, during a prolonged exposure to an ambient atmospheric pressure other than the pressure reigning inside the diving watch, or the depth gauge, for example during a trip of a plurality of days at altitude, the hydrogen particles finish by passing through the seals, then more slowly the oxygen particles, in such a way as to re-balance the pressures between the inside and the outside of the diving watch or of the depth gauge. This rebalancing of pressures causes a slow return of the pressure indicator organ in its reference position, opposite the indicator (index) of the theoretical zero.

This phenomenon of rebalancing pressures between the inside and the outside of the diving watch, or of the depth gauge, may also be accelerated by the various manipulations of the stem or push-pieces.

After such a rebalancing of pressures, and when the user returns, for example to sea level after a prolonged stay in a mountainous region, in view of performing a dive there, there will then be a differential pressure between the inside and the outside of the timepiece or of the depth gauge, and therefore an incorrect calibration of the theoretical zero of the pressure indicator organ, and consequently an erroneous measurement of the instantaneous depth during the dive. The user will have no other solution than to wait for a plurality of days for the rebalancing of pressures to initiate.

This lack of accuracy is currently difficult to accept by users, particularly faced with the accuracy provided by digital depth gauges for example.

To remedy these drawbacks, designers generally use a display trick at the graduation of the pressure, in such a way as to hide the alignment defects of the indicator organ with the theoretical zero of the graduation. This display trick consists in replacing the index of the theoretical zero with an extended zero area forming an angular sector arranged on the dial in such a way as to cover the possible position variations of the pressure indicator organ during small variations of the ambient pressure.

However, this display trick does not make it possible to accurately indicate the actual ambient pressure during a dive, because an offset may exist between the pressure indicated and the actual ambient pressure. Which is problematic given the importance of this information as previously mentioned.

### SUMMARY OF THE INVENTION

In this context, the invention proposes a timepiece mechanism, indicating information relating to the ambient pressure, comprising a zero-reset mechanism, for zero-resetting on demand, of an ambient pressure indicator organ making it possible to solve at least one problem previously raised, and particularly to overcome the display and calibration defects of an ambient pressure indicator organ before a dive.

The timepiece mechanism according to the invention thus proposes an innovative technical solution making it possible to meet the increasing accuracy requirements of users. The timepiece mechanism according to the invention makes it possible to reset on demand the organ indicating the ambient pressure measured before performing a dive, in order to overcome existing problems of relative pressures between the inside of the timepiece and the outside, due to the variations of the ambient atmospheric pressure.

To remedy this problem, the invention proposes to advantageously use a mechanical re-indexing of the measured pressure indicator organ making it possible to overcome any sealing problems with liquids that would be caused by the use of a stem or of a push-piece that is permeable making it possible for gas to enter or exit.

To this end, one object of the invention is a timepiece mechanism indicating information relating to the ambient pressure, said mechanism comprising:
an ambient pressure measuring device comprising an element configured to mechanically deform under the effect of a variation of the ambient pressure;
a first wheel assembly kinematically connected to the ambient pressure measuring device, in such a way as to be rotated under the effect of an ambient pressure variation;
a measured pressure indicator mechanism comprising a measured pressure indicator organ kinematically connected to a measured pressure display train;
   said timepiece mechanism being characterised in that it comprises:
a second wheel assembly configured to be in uncouplable connection with the first wheel assembly, such that the second wheel assembly is rotated by the rotation of the first wheel assembly under the effect of a pressure variation, when the second wheel assembly is coupled with the first wheel assembly; said second connected being kinematically connected to the measured pressure display train of the measured pressure indicator mechanism;
a zero-reset mechanism to position, on demand, said measured pressure indicator organ in a reference position, said zero-reset mechanism being configured to uncouple the second wheel assembly from the first wheel assembly and to modify the relative position of the second wheel assembly in relation to the first wheel assembly, in such a way as to position said measured pressure indicator organ in said reference position.

Thanks to the mechanism according to the invention, it is possible to reset to zero on demand, the measured pressure indicator mechanism before each dive in such a way as to optimise the ambient pressure measuring accuracy during dives, which particularly makes it possible to avoid certain uncertainties at the depth of the dive stops.

Apart from the features mentioned in the preceding paragraph, the timepiece according to the invention may have one or more additional features from the following, considered individually or according to all technically possible combinations:
the second wheel assembly is frictionally mounted with said first wheel assembly, such that a friction torque exists between the first wheel assembly and the second wheel assembly;
the zero-reset mechanism comprises:
   a blocking mechanism configured to block the angular position of the first wheel assembly, and
   a drive mechanism configured to apply on said second wheel assembly a drive torque and to modify the relative position between the first wheel assembly and the second wheel assembly, in such a way as to position said measured pressure indicator organ in said reference position, when the drive torque is greater than the friction torque existing between the first wheel assembly and the second wheel assembly;
said zero-reset mechanism comprises a zero-reset organ command, that can be actuated by the user, rotatable about a pivot, the zero-reset organ command being configured to actuate the blocking mechanism during a first angular phase then the drive mechanism during a second angular phase;
said blocking mechanism comprises:
   a zero-reset lever cooperating with said zero-reset organ command and set in motion during the effect of the zero-reset organ command;
   a blocking lever set in motion by said zero-reset lever, said blocking lever being movable between a rest position, wherein the rotation of the first wheel assembly is not blocked, and a blocking position wherein the rotation of the first wheel assembly is blocked;
the blocking lever comprises a blocking beak adapted to be inserted between two consecutive teeth of a toothing of a blocking train meshed with the first wheel assembly and to lock the angular position of said blocking train;
the blocking beak of the blocking lever and the toothing of the blocking train have a profile guaranteeing the locking of said blocking train when a tangential force is applied on the blocking train;
the zero-reset lever comprises a lever beak, the lever beak being configured to tip said blocking lever in its blocking position during the first angular phase of the zero-reset organ command and to hold the blocking lever in blocking position during a second angular phase of the zero-reset organ command.
the blocking lever comprises a return organ configured to reposition the blocking lever in its rest position;
the drive mechanism comprises:
   a zero-reset heart-piece having a balance position, said balance position corresponding to the reference position of the measured pressure indicator organ,
   a zero-reset hammer configured to reposition said zero-reset heart-piece in its balance position;
the drive mechanism comprises a drive wheel assembly kinematically connected to the measured pressure indicator mechanism and in that the zero-reset heart-piece is integral with the drive wheel assembly, such that the positioning of the zero-reset heart-piece in its balance position through the action of the hammer modifies the relative position of the second wheel assembly in relation to the first wheel assembly, in such a way as to position said measured pressure indicator mechanism in said reference position.
the hammer is integral with the zero-reset organ command;
the zero-reset mechanism comprises a retention organ configured to exert a retention force on said zero-reset organ command and to elastically deform when a force greater than the retention force is applied on said retention organ;
the retention organ comprises an elastic portion configured to elastically deform by buckling;
the retention organ cooperates directly with said zero-reset lever;
the mechanism according to the invention comprises a maximum pressure indication mechanism comprising a maximum pressure display train comprising a maximum pressure display wheel, said maximum pressure indication mechanism comprising a maximum pressure indicator organ integral with the maximum pressure display wheel; said drive mechanism configured to gradually drive the maximum pressure display train during an increase of the ambient pressure;
the drive mechanism comprises:
   a drive wheel assembly, integral with an arbor, meshed with the measured pressure display train;
   a follower wheel assembly freely mounted about the arbor of the drive wheel assembly, the follower wheel assemblyc being meshed with the maximum pressure display train; the drive wheel assembly being configured to drive the follower wheel assembly during an increase of the ambient pressure;
the drive mechanism comprises a drive pin integral with the drive wheel assembly and cooperating with an opening arranged in the follower wheel assembly;
said timepiece mechanism comprises an indexing mechanism to index the position of the maximum pressure display train at each advance, the indexing mechanism comprising a blocking organ cooperating with an indexing wheel assembly;
the indexing wheel assembly is kinematically connected to the maximum pressure display wheel by a gear train T1, T2 and in that the gear ratio of the gear train T1, T2 between the maximum pressure display wheel and the indexing wheel assembly is a multiplication ratio;
the indexing wheel assembly comprises an indexing toothed wheel comprising an asymmetric toothing, preferably a wolf-tooth toothing, said blocking organ cooperating with the asymmetric toothing of the indexing toothed wheel;
said blocking organ is an uncouplable blocking organ configured to be uncoupled by the zero-reset mechanism;
the blocking organ is configured to be uncoupled by the zero-reset organ command;
the indexing mechanism comprises a return organ configured to ensure a repositioning of the maximum pressure display train under the effect of a return element when the blocking organ is uncoupled.

The invention also relates to a depth gauge, an altimeter or a barometer integrating such a timepiece mechanism according to the invention.

The invention also relates to a timepiece comprising a horological movement, mechanical or electromechanical, comprising such a timepiece mechanism according to the invention.

Preferably, the timepiece is a diving watch.

### BRIEF DESCRIPTION OF THE FIGURES

The aims, advantages and features of the present invention will become apparent upon reading the following detailed description making reference to the following figures:

FIG. 1 is a schematic representation in perspective of a first example of embodiment of the timepiece mechanism according to the invention indicating information relating to the ambient pressure;

FIG. 2 is a schematic representation in top view of the example of embodiment of the timepiece mechanism according to the invention illustrated in FIG. 1;

FIG. 3 is a schematic representation in bottom view of the example of embodiment of the timepiece mechanism according to the invention illustrated in FIG. 1;

FIGS. 4a and 4b illustrate various positions of one portion of the blocking mechanism of the first example of embodiment of the timepiece mechanism according to the invention;

FIG. 5 is a perspective view of a second example of embodiment of the timepiece mechanism according to the invention indicating information relating to the ambient pressure and further comprising a maximum pressure indication mechanism;

FIG. 6 is a schematic representation in top view of the second example of embodiment of the timepiece mechanism according to the invention illustrated in FIG. 5;

FIG. 7 is a schematic representation in bottom view of the second example of embodiment of the timepiece mechanism according to the invention illustrated in FIG. 5;

FIG. 8 is a schematic representation in top view of the indexing wheel assembly of the example of embodiment of the timepiece mechanism according to the invention, illustrated in FIG. 5.

In all of the figures, the common elements bear the same reference numbers unless otherwise specified.

### DETAILED DESCRIPTION OF THE INVENTION

Generally, in the field of horology, and in the present application, the term arbor designates a part having the shape of a cylinder that generally supports a toothed wheel or a pinion.

### First Example of Embodiment

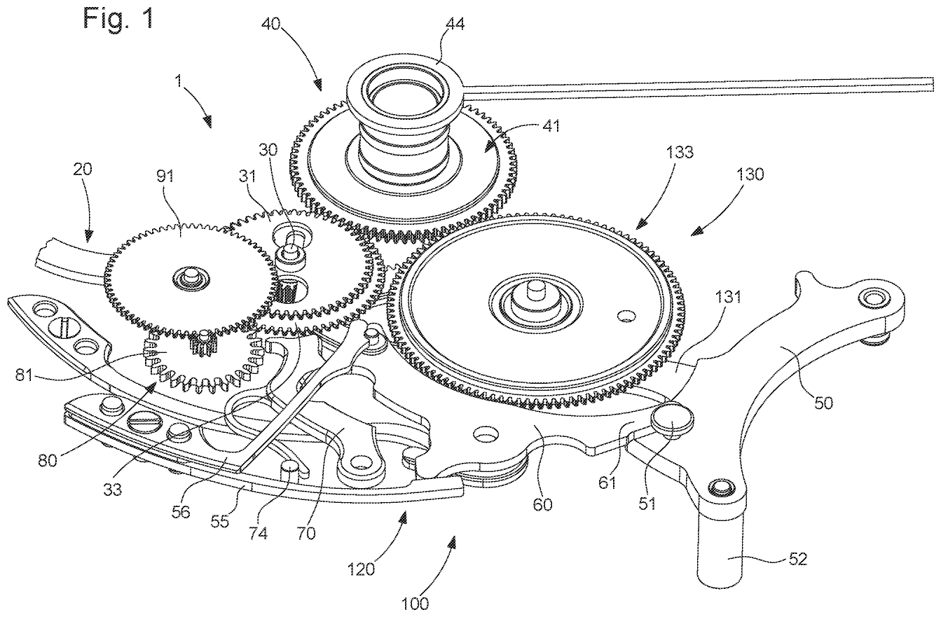

The first example of embodiment of the timepiece mechanism 1 indicating information relating to the ambient pressure according to the invention is illustrated in FIGS. 1 to 3.

FIG. 1 is a representation in perspective of the timepiece mechanism 1 indicating information relating to the ambient pressure according to the invention.

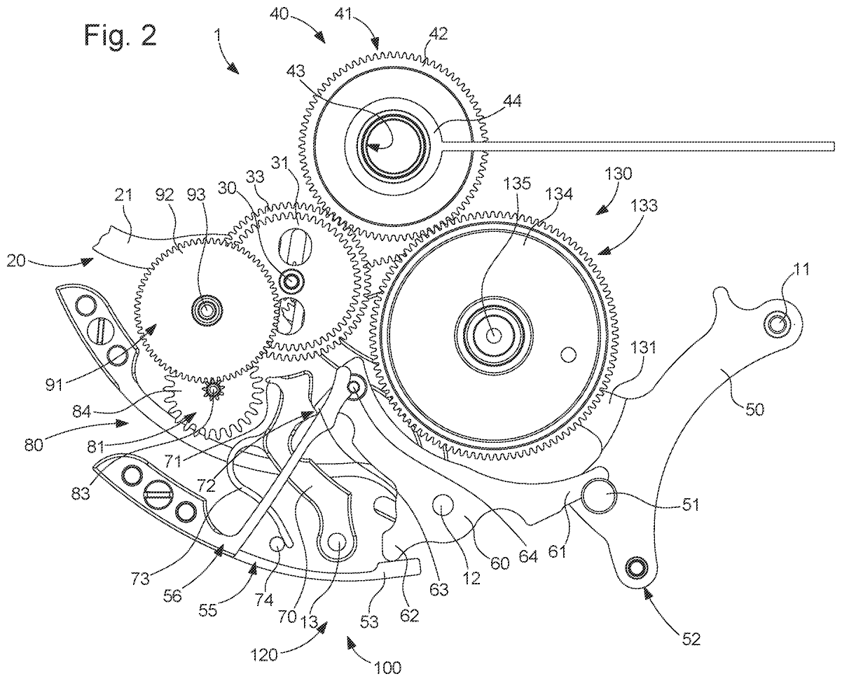

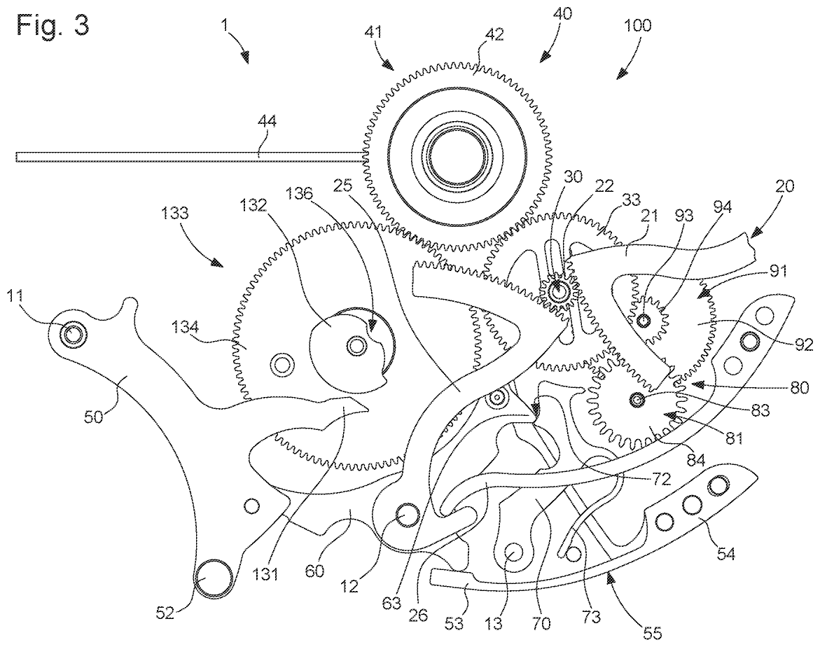

FIGS. 2 and 3 are respectively representations in top view and in bottom view of the first example of embodiment of the timepiece mechanism 1.

With reference to FIGS. 1 to 3, the timepiece mechanism 1 indicating information relating to the ambient pressure according to the invention comprises a first wheel assembly 31, integral with a first arbor 30, pivotally mounted on a frame (not shown). The first wheel assembly 31 is kinematically connected to an ambient pressure measuring device 20.

an ambient pressure measuring device 20 comprises an element (not shown) configured to mechanically deform under the effect of a variation of the ambient pressure.

The element configured to deform mechanically under the effect of a variation of the ambient pressure is for example a deformable flat membrane setting in motion a feeler-spindle.

The element configured to deform mechanically under the effect of a variation of the ambient pressure may also be an aneroid capsule comprising an aneroid box compressing or dilating depending on the ambient pressure.

The ambient pressure measuring device 20 is relatively conventional and is not shown in detail in FIGS. 1 to 3 for a better readability and understanding of the timepiece mechanism 1 according to the invention.

The ambient pressure measuring device 20 is arranged such that the displacements of the element configured to deform mechanically under the effect of a variation of the ambient pressure (deformable flat membrane, or aneroid capsule), are transmitted to the first wheel assembly 31, in the form of a rotation of the first arbor 30, by means of a transmission mechanism, such that the angular position of the first wheel assembly 31, and therefore of the first arbor 30, varies depending on the ambient pressure measured by the ambient pressure measuring device 20.

By way of example, the transmission mechanism of the ambient pressure measuring device 20 may comprise a rack 21, that can be seen more particularly in FIG. 3, at the end of the kinematic chain, directly meshing the first wheel assembly 31 or an intermediate wheel assembly meshed with the first wheel assembly 31.

More particularly, the first wheel assembly 31 comprises a pinion 22, integral with the first arbor 30, meshed with the rack 21 of the transmission mechanism of the ambient pressure measuring device 20, as shown in FIGS. 1 to 3.

Thus, the first wheel assembly 31 described above, integral with the pinion 22, angularly moves depending on the ambient pressure measured by the ambient pressure measuring device 20.

The timepiece mechanism 1 indicating information relating to the ambient pressure according to the invention also comprises a second wheel assembly 33 in uncouplable connection with the first wheel assembly 31.

The second wheel assembly 33 is superposed on the first wheel assembly 31, such that the second wheel assembly 33 is offset from the first wheel assembly 31 along the geometric axis of revolution of the first arbor 30. In the example of embodiment illustrated, the second wheel assembly 33 is positioned below the first wheel assembly 31.

By way of example, the second wheel assembly 33 is connected to the first wheel assembly 31, and more particularly to the first arbor 30 on which it is mounted, by friction, such that there is a friction torque, not zero, between the first wheel assembly 31 and the second wheel assembly 33.

Thus, the second wheel assembly 33 is arranged to be rotated in the same way as the first wheel assembly 31 under the effect of an ambient pressure variation by the ambient pressure measuring device 20, so long as a torque greater than the friction torque existing between the two wheel assemblies 31, 33 is not applied on one of the wheel assemblies 31, 33. In this configuration, the second wheel assembly 33 is said to be meshed with the first wheel assembly 31.

Thus, in normal operation, that is to say without outside action, by a zero-reset mechanism 100 that will be described subsequently, the first wheel assembly 31 and the second wheel assembly 33, frictionally mounted, are integrally comprised, such that a rotation of the first wheel assembly 31 also rotates the second wheel assembly 33, with the same angle of rotation.

The timepiece mechanism 1 also comprises a measured pressure indicator mechanism 40 kinematically linked to the second wheel assembly 33.

More particularly, the measured pressure indicator mechanism 40 comprises a measured pressure display train 41 kinematically linked to the second wheel assembly 33. The measured pressure display train 41 comprises for example a measured pressure display wheel 42, integral with a second arbor 43 pivotally mounted on the frame, and on which is mounted a measured pressure indicator organ 44, for example a hand, that can be seen by the user.

In the example of embodiment illustrated in FIGS. 1 to 3, the measured pressure display wheel 42 is directly meshed with the second wheel assembly 33.

However, depending on the needs and movement architectures, the measured pressure display train 41 may also comprise additional intermediate wheel assemblies positioned between the second wheel assembly 33 and the measured pressure display wheel 42 supporting the measured pressure indicator organ 44.

The measured pressure indicator mechanism 40 is configured to make it possible to rotate the measured pressure indicator organ 44 in line with a graduation (not shown) arranged on a dial. This rotation of the measured pressure indicator organ 44 may be linear depending on the pressure variation or non-linear. The graduation on the dial is consequently adapted depending on the linear or non-linear rotation of the measured pressure indicator organ 44.

The timepiece mechanism 1 also comprises a zero-reset mechanism 100 to calibrate and correct, at the request of the user, the position of the measured pressure indicator organ 44 and, if necessary, bring the measured pressure indicator organ 44 back in a reference position, indicating for example the theoretical zero.

As will be seen subsequently, the zero-reset mechanism 100 is configured to modify, on demand, the relative position (or the indexing) between the first wheel assembly 31, kinematically connected to the ambient pressure measuring device 20, and the second wheel assembly 33, kinematically connected to the measured pressure indicator mechanism 40.

To this end, the zero-reset mechanism 100 comprises a zero-reset lever organ command 50 that can be manipulated by the user via a push-piece, or an actuation stud 52, (that can be seen in FIG. 1), such that the zero-reset of the angular position of the measured pressure indicator organ 44 is performed at the request of the user.

The zero-reset lever organ command 50 is pivotally mounted about the first pivot 11 integral with the frame.

The zero-reset mechanism 100 also comprises:
a blocking mechanism 120 actuated by the zero-reset lever organ command 50 and configured to come to block on demand the angular position of the first wheel assembly 31 during the actuation of the zero-reset lever organ command 50;
a drive mechanism 130 actuated by the zero-reset lever organ command 50 and configured to modify on demand the relative position of the second wheel assembly 33 and reposition the measured pressure indicator organ 44 in a reference position, in such a way as to perform the zero-reset function.

The blocking mechanism 120 comprises a zero-reset lever 60 pivotally mounted about a second pivot 12 integral with the frame. The zero-reset lever 60 is configured to cooperate with the zero-reset lever organ command 50, for example by means of a first lever finger-piece 61 pressing on a portion of the zero-reset lever organ command 50, or pressing on a pin 51 integral with the body of the zero-reset lever organ command 50, as shown in FIGS. 1 to 3.

The zero-reset lever 60 is held pressing against the zero-reset lever organ command 50 by means of a first return organ 55 acting on a portion of the zero-reset lever 60, for example ata second lever finger-piece 62.

It will be noted that the first lever finger-piece 61 in contact with the zero-reset lever organ command 50 is radially farther away from the second pivot 12 than the second lever finger-piece 62 in contact with the first return organ 55.

According to the example of embodiment illustrated in FIGS. 1 to 3, the first return organ 55 is formed by a spring blade comprising a portion 54 integral with the frame and an elastic portion 53 configured to return the zero-reset lever 60 in a rest position. By means of the first lever finger-piece 61, the zero-reset lever 60 also brings the zero-reset lever organ command 50 back in a rest position when the use does not apply pressure on this zero-reset lever organ command 50.

The blocking mechanism 120 also comprises a blocking lever 70 pivotally mounted about a third pivot 13 integral with the frame, as well as a blocking train 80 comprising for example a blocking wheel assembly 81 and an intermediate blocking wheel assembly 91.

The blocking lever 70 is actuated directly by the zero-reset lever 60, and is configured to make it possible to block the rotation of the first wheel assembly 31 during the actuation of the zero-reset lever organ command 50.

The blocking lever 70 and the zero-reset lever 60 are configured in such a way that the rotational blocking of the first wheel assembly 31 occurs before the actuation of the drive mechanism 130 making it possible to modify the angular position of the second wheel assembly 33 in relation to the first wheel assembly 31.

Thus, the zero-reset mechanism 100 according to the invention is configured to make it possible to rotatably block the first wheel assembly 31 then possibly drive, via the drive mechanism 130, the second wheel assembly 33, successively.

To this end, the zero-reset lever 60 comprises a lever beak 63 cooperating with a portion of the blocking lever 70, forming a heel 72.

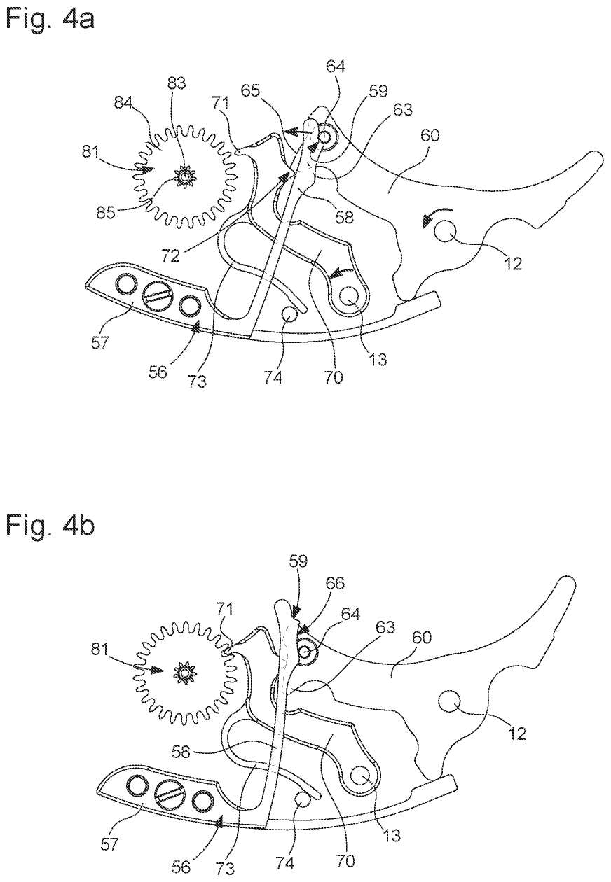

FIGS. 4a and 4b illustrate various positions of the blocking lever 70 and of the zero-reset lever 60 during the activation of the blocking mechanism 120 making it possible to understand their respective kinematic.

In rest position, i.e. when the blocking mechanism 120 is not in activated position, the lever beak 63 is in contact with the upper surface of the heel 72, as illustrated more particularly in FIG. 4a.

The shape of the heel 72 and of the lever beak 63 make it possible to rapidly tip the blocking mechanism 120 in an activated blocking position, as illustrated particularly in FIG. 4b, with a small pivoting of the zero-reset lever 60.

For this, in the rest position, the contact between the lever beak 63 and the upper surface of the heel 72 of the blocking lever 70 is clear such that there is little sliding between the lever beak 63 and the upper surface of the heel 72 in the first degrees of pivoting of the zero-reset lever 60. Advantageously, in rest position, the upper surface of the heel 72, in contact with the lever beak 63, is oriented substantially tangentially to the end of the lever beak 63.

The blocking lever 70 comprises a blocking beak 71 forming the terminal portion of a first end of the blocking lever 70, the blocking beak 71 being adapted to penetrate between two teeth of the toothing of the blocking wheel assembly 81 during the tipping of the blocking lever 70 in its blocking position.

The blocking beak 71 has a shape adapted to easily penetrate between two teeth of the toothing of the blocking wheel assembly 81 without jamming and to guarantee the locking of said blocking wheel assembly 81 when a tangential force or a torque is applied on the blocking wheel assembly 81.

Preferably, an operating clearance is arranged between the blocking beak 71 and the teeth of the toothing of the blocking wheel assembly 81, in such a way as to facilitate the insertion and the withdrawal of the blocking beak 71 without damaging elements during the actuation of the zero-reset lever organ command. To this end, the width of the blocking beak 71 is less than the spacing of the two consecutive teeth of the toothing of the blocking wheel assembly 81.

Preferably, the shape of the blocking beak 71 and the shape of the toothing of the blocking wheel assembly 81 are configured to prevent generating a back or return force on the blocking lever 70, thus risking disengaging the blocking beak 71 of the toothing of the blocking wheel assembly 81, when a torque is applied on the blocking wheel assembly 81. By way of example, the blocking wheel assembly 81 has a cycloid toothing, for example with an NHS profile.

The blocking beak 71 as well as the shape of the blocking lever 70 are configured such that in blocking position, the blocking beak 71 does not touch the tooth bottom of the toothing of the blocking wheel assembly 81, thus ensuring a certain operating clearance and also preventing a breakage or a wear of the mechanism.

From the position described above and illustrated in FIG. 4a, the rotation of the zero-reset lever 60 generates a pivoting of the blocking lever 70 about the third pivot 13, making the end of the lever beak 63 slide little by little towards the rounded end of the heel 72, and progressively bringing the blocking beak 71 between two teeth of the toothing of the blocking wheel assembly 81.

When the blocking beak 71 is positioned between two teeth of the toothing of the blocking wheel assembly 81, the rounded end of the heel 72 is in sliding contact with the upper surface 65 of the lever beak 63. Consequently, an additional pivoting of the zero-reset lever 60 does not generate additional rotation of the blocking lever 70 (or then small variations due to the surface state and/or to the profile of the parts in contact). In addition, the sliding of the lever beak 63 on the rounded end of the heel 72 makes it possible to hold the blocking beak 71 in blocking position between two teeth of the toothing of the blocking wheel assembly 81.

It will also be noted that the blocking lever 70 cooperates with a second return organ 73 to reposition the blocking lever 70 in a rest position and to disengage the blocking beak 71 of the toothing of the blocking wheel assembly 81 during the release of the zero-reset lever organ command 50.

By way of example, the second return organ 73 is integral with the body of the blocking lever 70 and stressed against the frame, or against an element integral with the frame, such as for example a pin 74, during the tipping of the blocking lever 70. During the release of the zero-reset lever organ command 50, the second return organ 73 under stress repositions the blocking lever 70 in its initial non-engaged position, i.e. the rest position. In this rest position, illustrated by FIG. 4a, the blocking beak 71 is not engaged in the toothing of the blocking wheel assembly 81.

The blocking wheel assembly 81 is integral with the third arbor 83 pivotally mounted on the frame. The blocking wheel assembly 81 comprises a blocking wheel 84 and a blocking pinion 85 integral with the blocking wheel 84.

The blocking wheel 84 has a toothing comprising a plurality of teeth. The shape of the blocking beak 71 of the blocking lever 70 is adapted to cooperate with the shape of the teeth of the toothing of the blocking wheel 84, such that the blocking beak 71 is configured to be able to penetrate between two teeth of the toothing of the blocking wheel 84, in such a way as to rotatably immobilise the blocking wheel assembly 81.

The pinion 85 of the blocking wheel assembly 81 meshes the intermediate blocking wheel assembly 91, and more particularly an intermediate blocking wheel 92 of the intermediate blocking wheel assembly 91.

The intermediate blocking wheel assembly 91 is integral with a fourth arbor 93 pivotally mounted on the frame and comprises the intermediate blocking wheel 92, integral with the fourth arbor 93, and a pinion 94, also integral with the fourth arbor 93. The pinion 94 of the intermediate blocking wheel assembly 91 is meshed with the first wheel assembly 31.

Thus, the rotational blocking of the blocking wheel 84 temporarily immobilises the rotation of the first wheel assembly 31 as well as the position of the rack 21 of the ambient pressure measuring device 20.

Apart from the blocking mechanism 120 that has just been described above making it possible to come to block the angular position of the first wheel assembly 31, the zero-reset mechanism 100 also comprises a drive mechanism 130 making it possible to reposition the measured pressure indicator organ 44 in an initial reference position, in such a way as to perform the zero-reset function.

To this end, the drive mechanism 130 comprises a zero-reset hammer 131 capable of cooperating with a zero-reset heart-piece 132.

In the example of embodiment illustrated in FIGS. 1 to 3, the hammer 131 is integral with the zero-reset lever organ command 50, such that the pivoting of the zero-reset lever organ command 50 directly moves the hammer 131 in the direction of the zero-reset heart-piece 132, in such a way as to come to strike it.

According to an alternative embodiment, the hammer 131 may be a part dissociated from the zero-reset lever organ command 50, and set in motion by the zero-reset lever organ command 50, for example by means of a lever.

It will be noted that the portion of the zero-reset lever organ command 50 intended to trigger the blocking mechanism 120, symbolised here by the pin 51 is radially farther away from the pivoting axis of the pivot 11 than the portion intended to trigger the drive mechanism 130, here symbolised by the hammer 131. Such an arrangement particularly makes it possible to obtain, for the same angle of rotation of the zero-reset lever organ command 50, a more significant action on the blocking mechanism 120 than on the drive mechanism 130 in such a way as to make sure that the blocking lever 70 is in fact in its blocking position before the hammer 131 comes to strike the zero-reset heart-piece 132 and that the drive mechanism 130 exerts a stress on the measured pressure display train 41.

The zero-reset heart-piece 132 is integral with a drive wheel assembly 133, integral with a fifth arbor 135 pivotally mounted on the frame. The drive wheel assembly 133 comprises a drive wheel 134 meshed with the measured pressure display wheel 42 integral with the second arbor 43 and supporting the measured pressure indicator organ 44.

The shape of the zero-reset heart-piece 132 makes it possible for the drive wheel assembly 133 to be angularly repositioned on the stable balance position 136 of the heart-piece 132, this stable angular position of the drive wheel assembly 133 corresponds to the reference position, for example to the theoretical zero of the measured pressure display wheel 42 and therefore of the measured pressure indicator organ 44.

Thus, the action of the hammer 131 on the zero-reset heart-piece 132 with a sufficient force makes it possible to effectively reposition the drive wheel assembly 133 in the reference position described above. The drive wheel assembly 133 being meshed with the measured pressure display wheel 42, the repositioning of the drive wheel assembly 133 drives the repositioning in a reference position of the measured pressure display wheel 42, and therefore of the measured pressure indicator organ 44.

The operation of the zero-reset mechanism 100 is the following.

During a first phase of actuating the zero-reset lever organ command 50, corresponding to a first angular phase of pivoting the zero-reset lever organ command 50, the pivoting of the zero-reset lever organ command 50 angularly moves the zero-reset lever 60 that tips the blocking lever 70 in blocking position, via the pressing of the lever beak 63 against the upper surface of the heel 72 of the blocking lever 70. The blocking beak 71 of the blocking lever 70 is thus positioned between two teeth of the toothing of the blocking wheel 84 of the blocking wheel assembly 81.

The blocking wheel assembly 81 is rotatably blocked rapidly from the first degrees of effect of the zero-reset lever organ command 50. Such a blocking before any other action advantageously makes it possible to prevent damage at the various trains of the kinematic chain connected to the pressure measuring device 20.

At the end of this first angular phase, the lever beak 63 is close to a tipping point of the heel 72, on the rounded end of the heel 72, such that an additional pivoting of the zero-reset lever 60 will not generate significant additional rotation of the blocking lever 70, and therefore of the blocking beak 71 already in activated position.

During a second phase of actuating the zero-reset lever organ command 50, corresponding to a second angular phase of the zero-reset lever organ command 50, the additional pivoting of the zero-reset lever organ command 50 continues to rotate the zero-reset lever 60. However, the contact between the zero-reset lever 60 and the blocking lever 70 is now sliding, the rounded end of the heel 72 being in sliding contact with the upper surface 65 of the lever beak 63. Thus, during this second angular phase, the blocking lever 70 is held in blocking position.

This second angular phase also makes it possible to bring the hammer 131 in contact with the zero-reset heart-piece 132. By providing sufficient energy on the zero-reset lever organ command 50, the heart-piece 132 is brought back in a stable balance position under the effect of the torque generated by the hammer 131, generally referred to as zero-reset torque of the heart-piece 132. This second angular phase thus makes it possible to reposition the drive wheel assembly 133 in the reference position corresponding to the stable balance position of the zero-reset heart-piece 132.

The first wheel assembly 31, kinematically connected to the pressure measuring device 20, being rotatably blocked by the blocking mechanism 120, and particularly by the blocking train 80 rotatably blocked by the blocking lever 70, the repositioning of the drive wheel assembly 133 has the effect of repositioning the measured pressure display wheel 42 in a reference position, and of modifying the relative positioning between the first wheel assembly 31, rotatably blocked, and the second wheel assembly 33 frictionally mounted in relation to the first wheel assembly 31, and kinematically connected to the drive wheel assembly 133, via the measured pressure display wheel 42.

This relative repositioning between the first wheel assembly 31 and the second wheel assembly 33 is permitted on the one hand due to the fact that the first wheel assembly 31 is rotatably blocked by the blocking mechanism 120 and on the other hand due to the fact that the torque applied at the second wheel assembly 33 by the drive mechanism 130 is greater than the friction torque existing between these two wheel assemblies 31, 33. Thus, in this second angular phase, the two wheel assemblies 31, 33 momentarily separate and take a new relative indexing.

The measured pressure indicator organ 44 is then calibrated, on demand, regardless of the active position of the pressure measuring device 20. Thus, the timepiece mechanism 1 according to the invention makes it possible to overcome problems of pressure differences, due to the variations of the atmospheric pressure having effects on the accuracy of indicating the pressure measured by the measuring device.

The timepiece mechanism 1 according to the invention also makes it possible to improve the accuracy of displaying the ambient pressure, particularly during dives from the first metres of depth.

The zero-reset mechanism 100 further comprises a retention organ 56 to secure the zero-reset mechanism 100 and ensure a complete activation of the drive mechanism 130. The retention organ 56 is configured to make it possible to activate the blocking mechanism 120 while momentarily keeping the activation of the drive mechanism 130 in a non-activated position while a certain force is not applied on the zero-reset lever organ command 50.

The retention organ 56 is an organ for protecting the drive mechanism 130 having a dynamic behaviour similar to a mechanical fuse.

In the example of embodiment illustrated in FIGS. 1 to 3, the retention organ 56 comprises a portion 57 integral with the frame and an elastic portion 58 arranged to exert the retention force against the actuation of the zero-reset lever organ command 50.

The elastic portion 58 is arranged to exert a retention force on the zero-reset lever 60 and to deform when a force greater than the retention force is applied on the elastic portion 58.

The zero-reset lever 60 comprises for example a stud 64 protruding in relation to the body of the zero-reset lever 60. The stud 64 is intended to be pressed against the elastic portion 58 of the retention organ 56. The elastic portion 58 is oriented substantially tangentially to the trajectory of the stud 64 such that it generates a retention force against the pivoting of the zero-reset lever 60 and therefore of the zero-reset lever organ command 50.

More particularly, the stud 64 presses against a retention notch 59 arranged at the free end of the elastic portion 58 of the retention organ 56. The retention notch 59 has a retention surface and a tipping point beyond which the retention organ 56 allows an additional, rapid and clear, tipping of the zero-reset lever 60 and of the zero-reset lever organ command 50, thus making it possible to completely actuate the drive mechanism 130, as well as place in contact the hammer 131 on the zero-reset heart-piece 132.

The retention notch 59 is arranged such that during the first angular phase, the stud 64 can slide at the retention notch 59 and allow a pivoting of the zero-reset lever 60 and therefore of the blocking lever 70 up to its blocking position (activated position). When the blocking lever 70 is in its activated position, the retention surface of the retention notch 59 is substantially perpendicular to the lever beak 63 of the zero-reset lever 60 such that the retention notch 59 creates a significant opposition force to the additional tipping of the zero-reset lever 60. To disengage from this position and arrive at the tipping point of the retention notch 59, the user must exert an additional force on the zero-reset lever organ command 50 to elastically deform the elastic portion 58 of the retention organ 56, by buckling, in such a way that the deformation by buckling of the elastic portion 58 combined with the pivoting of the zero-reset lever 60, allows the stud 64 to slide on the retention surface and to disengage from the retention notch 59 to come to slide along the lateral portion 66.

The energy provided by the user to override the retention force thus makes it possible to ensure the triggering of the drive mechanism 130 in its entirety by dynamic effect. The presence of a retention organ 56 in the zero-reset mechanism 100 makes it possible to overcome risks of an incomplete zero-reset by the user.

The retention organ 56 is configured so that the tipping point is reached by the stud 64 when a predetermined threshold torque is applied on the zero-reset lever organ command 50. The predetermined threshold torque depends on a certain elastic deformation during buckling of the elastic portion 58 making it possible for the stud 64 to no longer be retained by the shape of the retention notch 59, and at a certain angle of pivoting of the zero-reset lever 60.

The timepiece mechanism 1 also comprises a return rack 25 cooperating with an elastic return organ 26, that can be seen more particularly in FIG. 3, in such a way as to tension the train of the zero-reset mechanism 100, thus the relative clearances between the zero-reset mechanism 100 and the pressure measuring device 20 are eliminated.

The return rack 25 is meshed with the pinion 22 and the elastic return organ 26 acts on the return rack 25, and therefore on the pinion 22, in such a way as to ensure a permanent contact between the various parts of the pressure measuring device 20, such as particularly a feeler-spindle and a deformable membrane.

### Second Example of Embodiment

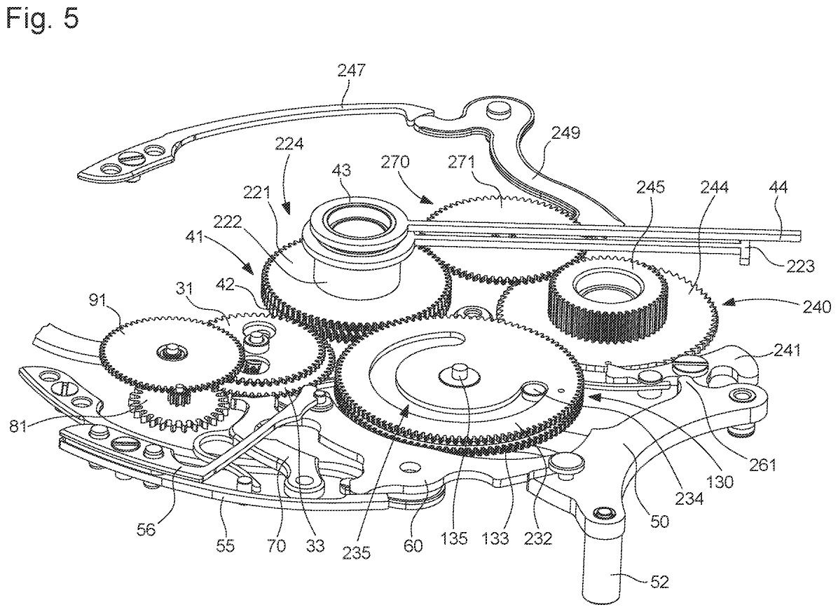

FIGS. 5 to 7 show a second example of embodiment of a timepiece mechanism 1′ indicating information relating to the ambient pressure according to the invention.

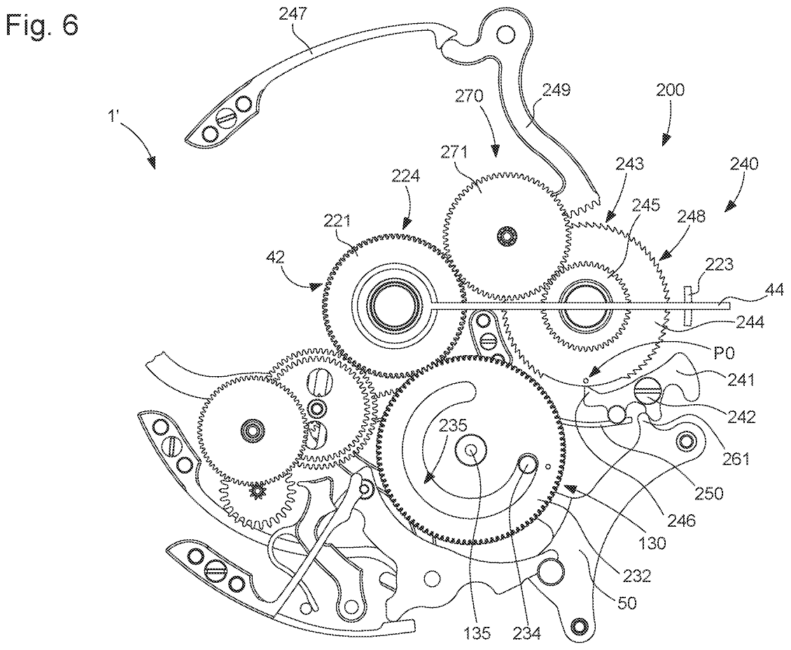

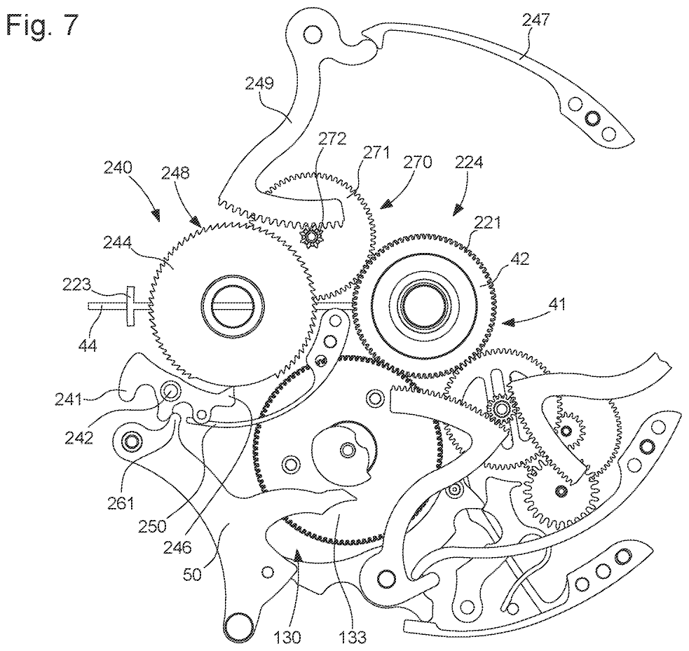

More particularly, FIG. 5 is a perspective view of a second example of embodiment of the timepiece mechanism 1′ according to the invention indicating information relating to the ambient pressure and further comprising a maximum pressure indication mechanism. FIG. 6 is a representation in top view of this second example of embodiment of the timepiece mechanism 1′. FIG. 7 a representation in bottom view of this second example of embodiment of the timepiece mechanism according to the invention illustrated in FIG. 5.

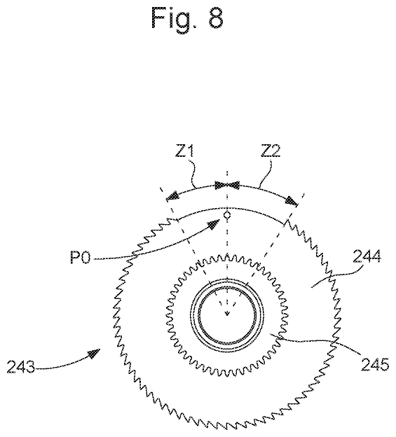

FIG. 8 is a representation in top view of the indexing wheel assembly of the example of embodiment of the timepiece mechanism 1′.

In this second example of embodiment, the timepiece mechanism 1′ is identical to the first example of embodiment with the exception of features that will be described subsequently.

In this second example of embodiment, the timepiece mechanism 1′ comprises all of the elements described above and also a mechanism for indicating the maximum pressure 200 reached making it possible for example to indicate the maximum depth reached during one or more dives, so long as the maximum pressure indication mechanism 200 is not reset to zero.

Such a maximum pressure indication mechanism 200 comprises a maximum pressure display train 224, comprising at least one maximum pressure display wheel 221, integral with an arbor 222 pivotally mounted on the frame. The maximum pressure display train 224 is kinematically connected to the measured pressure indication train 41.

In the example of embodiment illustrated in FIGS. 5 to 7, the maximum pressure display wheel 221 is coaxially mounted with the measured pressure display wheel 42, such that the two wheels 221, 42 are superposed. Thus, the arbor 222 of the maximum pressure display wheel 221 is concentric with the arbor 43 of the measured pressure display wheel 42. However, it is also envisaged to be able to position the maximum pressure display wheel 221 and the measured pressure display wheel 42 non-coaxially without departing from the context of the invention.

In the example of embodiment illustrated in FIGS. 5 to 7, the maximum pressure display wheel 221 and the measured pressure display wheel 42 are centred in relation to the centre of the mechanism. However, it is also envisaged to be able to position the maximum pressure display wheel 221 and the measured pressure display wheel 42 eccentrically in relation to the centre of the mechanism according to the invention, and particularly in relation to the centre of a horological movement integrating a mechanism according to the invention, in such a way as to be able to display information relating to the pressure outside of a central area of the horological movement generally dedicated to indicating time information.

The maximum pressure display wheel 221 is integral with a maximum pressure indicator organ 223, for example a hand integrally mounted on the arbor 222.

The maximum pressure display wheel 221 is capable of being driven gradually by the measured pressure display train 41, or by a wheel assembly kinematically connected to the measured pressure display train 41.

To this end, the drive mechanism 130 comprises in addition to the drive wheel assembly 133, described above, a follower wheel assembly 232 freely mounted about the fifth arbor 135 of the drive wheel assembly 133 and meshed with the maximum pressure display wheel 221. The follower wheel assembly 232 is therefore coaxial with the drive wheel assembly 133.

In this second example of embodiment, the drive wheel assembly 133 is a driver wheel assembly configured to gradually drive the follower wheel assembly 232 during an increase of the ambient pressure, measured by the pressure measuring device and depending on the relative position of the follower wheel assembly 232 in relation to the drive wheel assembly 133.

In this second example of embodiment, the drive mechanism 130 is also configured to make it possible to advance the angular position of the follower wheel assembly 232 when the angular position of the drive wheel assembly 133 becomes greater than the angular position of the follower wheel assembly 232.

The driving of the follower wheel assembly 232 by the drive wheel assembly 133 is performed by means of a drive pin 234 integral with the drive wheel assembly 133.

The drive pin 234 is pushed in the drive wheel assembly 133, and more particularly in an orifice arranged in the body of the drive wheel assembly 133 and protrudes in relation to the plate of the drive wheel assembly 133. The drive pin 234 is configured to be able to move inside an opening 235 arranged in the body of the follower wheel assembly 232 and to be able to drive the follower wheel assembly 232 when the drive pin 234 abuts against one end of the opening 235.

The opening 235 has an arc of circle shape the angular extent of which is configured substantially depending on the angular travel of the measured pressure display wheel 42.

Thus, the drive wheel assembly 133 can pivot freely without driving the follower wheel assembly 232 during a reduction of the ambient pressure and when the ambient pressure remains lower than the maximum pressure corresponding to the effective position of the follower wheel assembly 232.

The drive mechanism 130 operates in the following way. When the organs for indicating the measured pressure 44 and the maximum pressure 223 are in a reference position (theoretical zero) the drive wheel assembly 133 and the follower wheel assembly 232 are also in their initial reference position. In this case, the drive pin 234 abuts against one end of the opening 235 of the follower wheel assembly 232, as illustrated in FIG. 5.

During an increase in the ambient pressure measured by the ambient pressure measuring device 20, the drive wheel assembly 133 is rotated and pivots according to a first direction of rotation (for example in the anticlockwise direction). The two wheel assemblies 133, 232 being respectively in the same reference position, the rotation of the drive wheel assembly 133 also drives the rotation of the follower wheel assembly 232, the drive pin 234 abutting against one end of the opening 235. The follower wheel assembly 232 is thus driven in an angular position corresponding to the measured pressure.

During a reduction of the ambient pressure, the drive wheel assembly 133 pivots in the opposite direction (for example in the clockwise direction according to the architecture shown in FIGS. 5 to 7). The drive pin 234 then moves freely inside the opening 235. The drive wheel assembly 133 can thus freely return in an earlier angular position or in its initial reference position when the pressure is again zero (for example outside of the water) without driving the follower wheel assembly 232 that remains indexed in an angular position corresponding to the maximum pressure measured during the increase of the pressure described above.

When the ambient pressure increases again, the follower wheel assembly 232 will be rotated by the drive wheel assembly 133 when the measured pressure will become greater than the maximum pressure, corresponding to the effective angular position of the follower wheel assembly 232, that is to say when the drive pin 234 of the drive wheel assembly 133 will come back to abut against the end of the opening 235.

Thus, the angular position of the follower wheel assembly 232 corresponds to the maximum value of the pressure measured by the ambient pressure measuring device 20, so long as it is not reset to zero by the zero-reset lever organ command 50 described above.

The angular position of the follower wheel assembly 232, and therefore of the maximum pressure display wheel 221, is maintained at each advance by means of an uncouplable indexing mechanism 240, in such a way as to index the angular position of the follower wheel assembly 232 corresponding to the maximum measured value of the ambient pressure, since the last zero-reset of the mechanism.

The uncouplable indexing mechanism 240 is configured to block the angular position of the maximum pressure display wheel 221 at each advance of it, during phases of increase of the ambient pressure, such that the maximum pressure display wheel 21 remains indexed during a reduction of the ambient pressure.

The uncouplable indexing mechanism 240 comprises an uncouplable blocking organ, for example an indexing jumper 241, rotatable about a pivot 242 integral with the frame, between a coupled position and an uncoupled position.

The indexing jumper 241 cooperates with an indexing wheel assembly 243 comprising an indexing toothed wheel 244 and a central indexing pinion 245, integral with the indexing toothed wheel 244. The central indexing pinion 245 is kinematically connected to the maximum pressure display wheel 221.

The indexing toothed wheel 244 cooperates with the indexing jumper 241, and more particularly with a jumper beak 246, in such a way as to block the position of the maximum pressure display wheel 221, by means of the central indexing pinion 245, at each advance of the maximum pressure display wheel 221.

The indexing toothed wheel 244 has an asymmetric toothing 248, for example a wolf-tooth toothing, in such a way as to make possible a clear indexing without clearance and without backward return possible of the maximum pressure display wheel 221, particularly thanks to the straight flanks of the teeth of the asymmetric toothing 248.

However, according to alternative embodiments it is possible to use another type of toothing.

The indexing jumper 241 cooperates with a spring blade 250 exerting a force on the indexing jumper 241 in such a way as to position it by default in its coupled position and to ensure the positioning of the indexing jumper 241, and more particularly the jumper beak 246, at the tooth bottom of the toothing of the indexing toothed wheel 244.

The indexing toothed wheel 244 has a reference indexing position corresponding for example to the theoretical zero of the pressure measured by the ambient pressure measuring device 20. In such a way as to easily see this reference indexing position, the indexing toothed wheel 244 advantageously has an indexing symbol or marking, referenced P0, arranged on the plate of the indexing toothed wheel 244. When this indexing symbol is positioned opposite the jumper beak 246, the indexing toothed wheel 244 is in its reference indexing position, as illustrated in FIG. 6.

As shown in FIGS. 5 to 8, the indexing toothed wheel 244 may have a toothed sector less than 360° such that it may comprise one, or more, areas, known as non-indexing, that are characterised by one, or more, smooth angular portions, i.e. devoid of at least one indexing tooth, and preferably of a plurality of indexing teeth. Advantageously, these non-indexing areas make it possible to render the indexing function inactive on certain angular portions of the indexing toothed wheel 244, in such a way as to not index the position of the maximum pressure indicator organ 223, over certain ambient pressure value ranges, corresponding to certain situations predefined by the designer.

Advantageously, the indexing toothed wheel 244 comprises at least one angular sector, devoid of at least one tooth or a plurality of indexing teeth, located close to the indexing symbol, referenced P0, such that the indexing toothed wheel 244 has a portion devoid of indexing teeth close to its reference indexing position in relation to the jumper beak 246.

Advantageously, the indexing toothed wheel 244 comprises a first angular sector Z1 without indexing teeth positioned in such a way as to render the indexing inactive during small pressure variations, beyond the theoretical zero, for example for variations of the ambient pressure measured during a dive of less than a few metres, for example of less than 1 m, or to prevent indexing the maximum pressure indicator organ 223 during slight modifications of the atmospheric pressure.

For example, and according to the example of embodiment illustrated in FIGS. 5 to 8, the first angular sector Z1, devoid of at least one indexing tooth, is typically positioned between the indexing symbol P0 and the inclined flank of a first tooth of the asymmetric toothing 248, as symbolised in FIG. 8.

Advantageously, the indexing toothed wheel 244 may also comprise a second angular sector Z2 without indexing teeth positioned in such a way as to render the indexing inactive when the ambient pressure exceeds the maximum value of the display dedicated to the maximum pressure, for example a display appearing on a dial. Thus, the position of the maximum depth indicator organ 223 may not be indexed in a position located beyond the maximum value provided by the display.

Thus, in our preceding example, the second angular sector Z2 devoid of at least one indexing tooth is positioned after the straight flank of a last tooth corresponding to the last desired indexing position, or between the indexing symbol P0 and the straight flank of a last tooth of the asymmetric toothing 248, as symbolised in FIG. 8.

The zero-reset of the maximum pressure display train 224 is ensured by the zero-reset lever organ command 50 also serving to reset the mechanism of the angular position of the measured pressure indicator organ 44.

The zero-reset lever organ command 50 comprises an additional finger-piece 261 capable of forming a pivoting yoke of the indexing jumper 241. The actuation by the user of the zero-reset lever organ command 50 must overcome the return force of the spring blade 250 to make possible the pivoting of the indexing jumper 241 and its disengagement from the toothing 248 of the indexing toothed wheel 244.

Advantageously, the finger-piece 261 acts on the indexing jumper 241 during the second angular phase of the pivoting of the zero-reset lever organ command 50. Such that the complete actuation of the zero-reset lever organ command 50 makes it possible to both reset to zero the maximum pressure display train 224 and the measured pressure display train 41.

The uncouplable indexing mechanism 240 also comprises a third return organ 249, for example a return rack, cooperating with a return element 247 capable of exerting a return force on the third return organ 249. The third return organ 249 is kinematically connected to the maximum pressure display train 224, and more particularly to the maximum pressure display wheel 221. Thus, the third return organ 249 makes it possible to tension the maximum pressure display train 224 and the drive mechanism 130, which makes it possible to prevent fluttering of the maximum pressure indicator organ 223, caused by the operating clearances existing between the various gears of the train.

Via the return element 247, the third return organ 249 also exerts a return force on the maximum pressure display wheel 221 capable of repositioning the maximum pressure display wheel 221 and the maximum pressure indicator organ 223 in a reference position, for example the theoretical zero, when the indexing jumper 241 is brought in uncoupled position by the zero-reset lever organ command 50.

The return element 247 is for example a return spring.

As seen above, the indexing wheel assembly 243 is kinematically connected to the maximum pressure display wheel 221.

According to a first alternative embodiment, not illustrated, the indexing wheel assembly 243 is directly meshed with the maximum pressure display wheel 221, for example by means of the central indexing pinion 245, such that a first gear train T1 is formed between the maximum pressure display wheel 221 and the indexing wheel assembly 243.

According to a second alternative embodiment, illustrated more particularly in FIGS. 5 to 7, the uncouplable indexing mechanism 240 further comprises an intermediate indexing wheel assembly 270 positioned between the indexing wheel assembly 243 and the maximum pressure display wheel 221, such that the indexing wheel assembly 243 is kinematically connected to the maximum pressure display wheel 221 by means of this intermediate indexing wheel assembly 270. In this alternative embodiment, the maximum pressure display wheel 221, the intermediate indexing wheel assembly 270 and the indexing wheel assembly 243 form a second gear train T2.

Regardless of the alternative embodiment, the various gears constituting the gear trains T1 or T2 are configured such that the gear ratio, resulting between the maximum pressure display wheel 221 and the indexing wheel assembly 243, is a multiplication ratio.

Thus, with a multiplication ratio between the maximum pressure display wheel 221 and the indexing wheel assembly 243, the mechanism advantageously makes it possible to be able to increase the possible indexing positions of the maximum pressure indicator organ 223, which makes it possible to increase the maximum pressure display resolution.

The use of a multiplication ratio between the maximum pressure display wheel 221 and the indexing wheel assembly 243 particularly makes it possible to get closer to the display and accuracy results of a friction drive mechanism while proposing a mechanism of simpler design with an optimised and reduced compactness.

The use of an intermediate indexing wheel assembly 270 advantageously makes it possible to produce an intermediate wheel in such a way as to offset the indexing wheel assembly 243 outside of an area close to the arbor 222 of the maximum pressure display wheel 221. Thus, the installation of various elements of the maximum pressure indication mechanism 20, in a movement is facilitated and the thickness of the mechanism is minimised. Advantageously, the intermediate indexing wheel assembly 270 makes it possible to offset the indexing wheel assembly 243 from the central region of the mechanism that generally comprises an accumulation of indicator organs on the same arbor. Thus, the installation is facilitated and the overall thickness of the mechanism is minimised according to the invention, and particularly of a horological movement integrating such a mechanism.

More particularly, the intermediate indexing wheel assembly 270 comprises an intermediate indexing wheel 271 meshed on the one hand with the maximum pressure display wheel 221 and meshed on the other hand with the central indexing pinion 245 of the indexing wheel assembly 243.

The intermediate indexing wheel assembly 270 also comprises an intermediate indexing pinion 272 (that can be seen in FIG. 7). In the example of embodiment illustrated in FIGS. 5 to 7, the third return organ 249 is meshed with an intermediate indexing pinion 272 in such a way as to apply the return force on the maximum pressure display train 224. Such an installation advantageously makes it possible to reduce the angular travel of the third return organ 249, and thus facilitate the installation of various elements of the mechanism according to the invention.

However, other constructions are possible without departing from the context of the invention.

According to one alternative embodiment, the third return organ 249 may cooperate for example with the indexing wheel assembly 243, and be meshed on the central indexing pinion 245 of the indexing wheel assembly

By way of example, the indexing wheel assembly 243 comprises 62 machined teeth, which corresponding to an indexing wheel assembly comprising 73 teeth over at total circumference of 360°.

Thus, in the example of embodiment presented, the indexing wheel assembly 243 makes it possible to perform 62 indexing positions of the maximum pressure indicator organ 223. Thus, it is possible to have a more precise resolution in the display of the maximum pressure reached.

In this second example of embodiment, the timepiece mechanism 1′ makes it possible to indicate information relating to the ambient pressure as well as information relating to the maximum pressure reached with few additional parts and with a reduced overall size.

The timepiece mechanism 1′ according to the invention advantageously makes it possible to be able to perform a zero-reset function both of the measured pressure indicator organ 44 and of the maximum pressure indicator organ 201, simultaneously, and with a single zero-reset lever organ command 50, thus facilitating the manipulations before a dive.

Advantageously, the timepiece mechanism 1′ according to the invention comprises:
an ambient pressure measuring device 20 comprising an element configured to deform mechanically under the effect of a variation of the ambient pressure;
a measured pressure display train 41 kinematically linked to the ambient pressure measuring device 20, in such a way as to be rotated under the effect of a variation of the ambient pressure;
a maximum pressure indication mechanism 200 comprising a maximum pressure display train 224 comprising a maximum pressure display wheel 221, said maximum pressure indication mechanism 200 comprising a maximum pressure indicator organ 223 integral with the maximum pressure display wheel 221;
a drive mechanism 130 configured to gradually drive the maximum pressure display train 224 during an increase of the ambient pressure;
an indexing mechanism 240 index the position of the maximum pressure display train 224 at each advance, the indexing mechanism 240 comprising a blocking organ cooperating with an indexing wheel assembly 243;
   the timepiece mechanism 1′ being characterised in that the indexing wheel assembly 243 is kinematically connected to the maximum pressure display wheel 221 by a gear train T1, T2 and in that the gear ratio of the gear train T1, T2 between the maximum pressure display wheel 221 and the indexing wheel assembly 243 is a multiplication ratio.

Advantageously, the indexing wheel assembly 243 comprises a central indexing pinion 245 meshed with the maximum pressure display wheel 221, such that said gear train T1 is formed by the cooperation of the maximum pressure display wheel 221 and of the central indexing pinion 245.

Advantageously, the indexing mechanism 240 comprises an intermediate indexing wheel assembly 270 inserted between the maximum pressure display wheel 221 and the indexing wheel assembly 243 such that said gear train T2 is formed by the cooperation between the maximum pressure display wheel 221, the intermediate indexing wheel assembly 270 and the indexing wheel assembly 243; thus, the intermediate indexing wheel assembly 270 acts as an intermediate wheel and makes it possible to offset the indexing wheel assembly 243 from the wheel assembly of the maximum pressure indicator organ 223, which makes it possible to install more easily the mechanism according to the invention.

Advantageously, the indexing wheel assembly 243 comprises a central indexing pinion 245 meshed with the intermediate indexing wheel assembly 270, such that said gear train T2 is formed by the cooperation between the maximum pressure display wheel 221, the intermediate indexing wheel assembly 270 and the central indexing pinion 245.

Advantageously, the indexing wheel assembly 243 comprises an indexing toothed wheel 244 integral with the central indexing pinion 245.

Advantageously, the indexing toothed wheel 244 comprises an asymmetric toothing 248 comprising a plurality of indexing teeth, preferably a wolf-tooth toothing, said blocking organ cooperating with the asymmetric toothing 248 of the indexing toothed wheel 244.

Advantageously, the indexing toothed wheel 244 comprises a toothed sector less than 360°, such that said indexing toothed wheel 244 comprises at least one angular sector devoid of at least one indexing tooth.

Advantageously, said at least one angular sector devoid of at least one indexing tooth is positioned close to a reference indexing position of the indexing wheel assembly 243.

Advantageously, the blocking organ is a blocking organ, for example an indexing jumper 41, that can be uncoupled via a zero-reset lever organ command 50.

Advantageously, the indexing mechanism 240 comprises a return organ 249, known as third return organ, configured to ensure a repositioning of the maximum pressure display train 224 under the effect of a return element 247.

Advantageously, the third return organ 249 cooperates with the indexing wheel assembly 243.

Advantageously, the third return organ 249 cooperates with the intermediate indexing wheel assembly 270.

Advantageously, the third return organ 249 cooperates with an intermediate indexing pinion 272 of the intermediate indexing wheel assembly 270.

Advantageously, the drive mechanism 130 comprises a drive wheel assembly 133, forming a first wheel assembly, integral with an arbor 135, meshed with the measured pressure display train 41, and a follower wheel assembly 232, forming a second wheel assembly, freely mounted about the arbor 135 of the drive wheel assembly 133, the follower wheel assembly 232 being meshed with the maximum pressure display train 224, the drive wheel assembly 133 being configured to drive the follower wheel assembly 232 during an increase of the ambient pressure.

Advantageously, the drive mechanism 130 comprises a drive pin 234 integral with the drive wheel assembly 133 cooperating with an opening 235 arranged in the follower wheel assembly 232.

The timepiece mechanism 1, 1′ according to the invention may be combined with a horological movement configured to indicate information relating to time information.

The invention also relates to a depth gauge, an altimeter or a barometer integrating such a timepiece mechanism 1, 1′ as described above according to the first example or the second example of embodiment.

The invention also relates to a timepiece, such as a diving watch, comprising a horological movement comprising such a timepiece mechanism 1, 1′ making it possible to measure and indicate information relating to the ambient pressure, to indicate the maximum pressure reached and to reset to zero by means of a unique control the organs for indicating the ambient pressure and the maximum pressure reached in order to correctly calibrate the timepiece mechanism 1, 1′, for example before a dive.

1. A timepiece mechanism (1, 1′) indicating information relating to the ambient pressure, said mechanism comprising:
an ambient pressure measuring device (20) comprising an element configured to deform mechanically under the effect of a variation of the ambient pressure;
a first wheel assembly (31) kinematically connected to the ambient pressure measuring device (20), in such a way as to be rotated under the effect of an ambient pressure variation;
a measured pressure indicator mechanism (40) comprising a measured pressure indicator organ (44) kinematically connected to a measured pressure display train (41);
said timepiece mechanism (1, 1′) comprises:
a second wheel assembly (33) configured to be in uncouplable connection with the first wheel assembly (31), such that the second wheel assembly (33) is rotated by the rotation of the first wheel assembly (31) under the effect of a pressure variation, when the second wheel assembly (33) is coupled with the first wheel assembly (31); said second wheel assembly (33) being kinematically connected to the measured pressure display train (41) of the measured pressure indicator mechanism (40);
a zero-reset mechanism (100) to position, on demand, said measured pressure indicator organ (44) in a reference position, said zero-reset mechanism (100) being configured to uncouple the second wheel assembly (33) from the first wheel assembly (31) and to modify the relative position of the second wheel assembly (33) in relation to the first wheel assembly (31), in such a way as to position said measured pressure indicator organ (44) in said reference position.

2. The timepiece mechanism (1, 1′) indicating information relating to the ambient pressure according to claim 1, wherein said second wheel assembly (33) is frictionally mounted with said first wheel assembly (31), such that a friction torque exists between the first wheel assembly (31) and the second wheel assembly (33).

3. The timepiece mechanism (1, 1′) indicating information relating to the ambient pressure according to claim 1, wherein said zero-reset mechanism (100) comprises:
a blocking mechanism (120) configured to come to block the angular position of the first wheel assembly (31), and
a drive mechanism (130) configured to apply on said second wheel assembly (33) a drive torque and to modify the relative position between the first wheel assembly (31) and the second wheel assembly (33), in such a way as to position said measured pressure indicator organ (44) in said reference position, when the drive torque is greater than the friction torque existing between the first wheel assembly (31) and the second wheel assembly (33).

4. The timepiece mechanism (1, 1′) indicating information relating to the ambient pressure according to claim 3, wherein said zero-reset mechanism (100) comprises a zero-reset lever organ command (50), that can be actuated by the user, rotatable about a pivot (11), the zero-reset lever organ command (50) being configured to actuate the blocking mechanism (120) during a first angular phase then the drive mechanism (130) during a second angular phase.

5. The timepiece mechanism (1, 1′) indicating information relating to the ambient pressure according to claim 4, wherein said blocking mechanism (120) comprises:
a zero-reset lever (60) cooperating with said zero-reset lever organ command (50) and set in motion during the effect of the zero-reset lever organ command (50);
a blocking lever (70) set in motion by said zero-reset lever (60), said blocking lever (70) being movable between a rest position, wherein the rotation of the first wheel assembly (31) is not blocked, and a blocking position wherein the rotation of the first wheel assembly (31) is blocked.

6. The timepiece mechanism (1, 1′) indicating information relating to the ambient pressure according to claim 5, wherein the blocking lever (70) comprises a blocking beak (71) adapted to be inserted between two consecutive teeth of a toothing of a blocking train (80) meshed with the first wheel assembly (31) and to lock the angular position of said blocking train (80).

7. The timepiece mechanism (1, 1′) indicating information relating to the ambient pressure according to claim 6, wherein said blocking beak (71) of the blocking lever (70) and the toothing of the blocking train (80) have a profile guaranteeing the locking of said blocking train (80) when a tangential force is applied on the blocking train (80).

8. The timepiece mechanism (1, 1′) indicating information relating to the ambient pressure according to claim 5, wherein the zero-reset lever (60) comprises a lever beak (63), the lever beak (63) being configured to tip said blocking lever (70) in its blocking position during the first angular phase of the zero-reset lever organ command (50) and to hold the blocking lever (70) in blocking position during a second angular phase of the zero-reset (50).

9. The timepiece mechanism (1, 1′) indicating information relating to the ambient pressure according to claim 5, wherein the blocking lever (70) comprises a return organ (73) configured to reposition the blocking lever (70) in its rest position.

10. The timepiece mechanism (1, 1′) indicating information relating to the ambient pressure according to claim 3, wherein the drive mechanism (130) comprises:
a zero-reset heart-piece (132) having a balance position (136), said balance position corresponding to the reference position of the measured pressure indicator organ (44),
a zero-reset hammer (131) configured to reposition said zero-reset heart-piece (132) in its balance position (136).

11. The timepiece mechanism (1, 1′) indicating information relating to the ambient pressure according to claim 10, wherein the drive mechanism (130) comprises a drive wheel assembly (133) kinematically connected to the measured pressure indicator mechanism (40) and in that the zero-reset heart-piece (132) is integral with the drive wheel assembly (133), such that the positioning of the zero-reset heart-piece (132) in its balance position (136) through the action of the hammer (131) modifies the relative position of the second wheel assembly (33) in relation to the first wheel assembly (31), in such a way as to position said measured pressure indicator organ (44) in said reference position.

12. The timepiece mechanism (1, 1′) indicating information relating to the ambient pressure according to claim 10, wherein said zero-reset mechanism (100) comprises a zero-reset lever organ command (50), that can be actuated by the user, rotatable about a pivot (11), the zero-reset lever organ command (50) being configured to actuate the blocking mechanism (120) during a first angular phase then the drive mechanism (130) during a second angular phase, and wherein the hammer (131) is integral with the zero-reset lever organ command (50).

13. The timepiece mechanism (1, 1′) indicating an ambient pressure variation according to claim 1, wherein said zero-reset mechanism (100) comprises a retention organ (56) configured to exert a retention force on said zero-reset lever organ command (50) and to elastically deform when a force greater than the retention force is applied on said retention organ (56).

14. The timepiece mechanism (1, 1′) indicating an ambient pressure variation according to claim 1, wherein said retention organ (56) comprises an elastic portion (58) configured to elastically deform by buckling.

15. The timepiece mechanism (1, 1′) indicating an ambient pressure variation according to claim 13, wherein the retention organ (56) cooperates directly with said zero-reset lever (60).

16. The timepiece mechanism (1′) indicating information relating to the ambient pressure according to claim 1, further comprising a maximum pressure indication mechanism (220) comprising a maximum pressure display train (224) comprising a maximum pressure display wheel (221), said maximum pressure indication mechanism (220) comprising a maximum pressure indicator organ (223) integral with the maximum pressure display wheel (221); said drive mechanism (130) configured to gradually drive the maximum pressure display train (224) during an increase of the ambient pressure.

17. The timepiece mechanism (1′) indicating information relating to the ambient pressure according to claim 16, wherein the drive mechanism (130) comprises:
a drive wheel assembly (133), integral with an arbor (135), meshed with the measured pressure display train (41);
a follower wheel assembly (232) freely mounted about the arbor (135) of the drive wheel assembly (133), the follower wheel assembly (232) being meshed with the maximum pressure display train (224); the drive wheel assembly (133) being configured to drive the follower wheel assembly (232) during an increase of the ambient pressure.

18. The timepiece mechanism (1′) indicating information relating to the ambient pressure according to claim 17, wherein the drive mechanism (130) comprises a drive pin (234) integral with the drive wheel assembly (133) and cooperating with an opening (235) arranged in the follower wheel assembly (232).

19. The timepiece mechanism (1′) indicating information relating to the ambient pressure according to claim 16, wherein said timepiece mechanism (1′) comprises an indexing mechanism (240) to index the position of the maximum pressure display train (224) at each advance, the indexing mechanism (240) comprising a blocking organ (241) cooperating with an indexing wheel assembly (243).

20. The timepiece mechanism (1′) indicating information relating to the ambient pressure according to claim 19, wherein the indexing wheel assembly (243) is kinematically connected to the maximum pressure display wheel (221) by a gear train T1, T2 and in that the gear ratio of the gear train T1, T2 between the maximum pressure display wheel (221) and the indexing wheel assembly (243) is a multiplication ratio.

21. The timepiece mechanism (1′) indicating information relating to the ambient pressure according to claim 19, wherein the indexing wheel assembly (243) comprises an indexing toothed wheel (244) comprising an asymmetric toothing (248), preferably a wolf-tooth toothing, said blocking organ (241) cooperating with the asymmetric toothing (248) of the indexing toothed wheel (244).

22. The timepiece mechanism (1′) indicating information relating to the ambient pressure according to claim 19, wherein said blocking organ (241) is an uncouplable blocking organ configured to be uncoupled by the zero-reset mechanism (100).

23. The timepiece mechanism (1′) indicating information relating to the ambient pressure according to claim 4, wherein said blocking organ (241) is configured to be uncoupled by the zero-reset lever organ command (50).

24. The timepiece mechanism (1′) indicating information relating to the ambient pressure according to claim 22, wherein the indexing mechanism (240) comprises a return organ (249) configured to ensure a repositioning of the maximum pressure display train (224) under the effect of a return element (247) when the blocking organ (241) is uncoupled.

25. A depth gauge comprising a timepiece mechanism (1, 1′) according to claim 1.

26. An altimeter comprising a timepiece mechanism (1, 1′) according to claim 1.

27. A horological movement comprising a timepiece mechanism (1, 1′) according to claim 1.

28. A timepiece, such as a diving watch, comprising a horological movement according to claim 27.
